(19) United States
(12) Patent Application Publication
(10) Pub. No.: US 2008/0096787 A1
(43) Pub. Date: Apr. 24, 2008

(54) Solvent and method of making a solvent

(76) Inventors: Phillip L. Cauley, Bullard, TX (US); Tracy L. Edwards, Flint, TX (US)

Correspondence Address: LOREN G. HELMREICH, 5718 WESTHEIMER, SUITE 1800, HOUSTON, TX, 77057, US

(21) Appl. No.: 11/585,708

(22) Filed: Oct. 24, 2006

(51) Int. Cl. C11D 17/00

(52) U.S. Cl. 510/407

(57) ABSTRACT

A method of manufacturing a solvent from rubber tires includes a heated enclosure 66 through the heated a flow line with a temperature gradient of at least 150 F.°, and a rotary drum 74 in fluid communication with the flow line and condenser units 94, 98 to receive vapors output hydrocarbons. The solvent contains a high percent by weight of both limonene and naphthalene.

### FIELD OF THE INVENTION

The present invention relates to solvents, and more particularly to solvents of the type commonly used to dissolve paraffin waxes, asphaltenes, sludges and similar deposits in oilfield operations, pipelines, and tanks. The present invention also relates to the method of making a solvent.

### BACKGROUND OF THE INVENTION

Paraffin and asphaltene deposition in the oilfield has long been a serious problem in terms of production cost. Treating paraffin/asphaltene deposits with solvents has proved to be successful. Typical solvents used are xylene, toluene, limonene, condensate, petroleum distillates, and various mixtures of solvents. In most cases, no single solvent will dissolve all paraffin wax deposits due to the wide spectrum of waxes present.

Many current solvents are formulated in combination via blending techniques. Limonene, produced via citrus by-products, xylenes and toluenes are blended in ratios to satisfy various desired characteristics. Since limonene produced as a citrus by-product is relatively expensive, typically a small percent of limonene by weight is used in a solvent.

Publication US2004/0192980 discloses a process for converting organic waste material into useful byproducts. U.S. Pat. No. 6,149,881 discloses a method of increasing the limonene production during pyrolysis of scrap tires. A liquid fraction of the pyrolysis byproduct allegedly has about 51% limonene. The process disclosed in this patent is a batch process which is quite different than a continuous process. An article entitled “Formation of dl-limonene in used tire vacuum pyrolysis oils” discloses pulling off condensate at select locations within the system to enhance the amount of limonene in the liquid. Neither of these systems are well suited for operating on a continuous basis to utilize a high volume of tire material to produce a significant amount of solvent.

The disadvantages of the prior art are overcome by the present invention, and an improved solvent and a method of making a solvent are hereinafter disclosed.

### SUMMARY OF THE INVENTION

In one embodiment, the solvent comprises by weight a majority of C10 through C25 hydrocarbon materials (hydrocarbons), including at least 6% by weight limonene and 6% by weight naphthalenes. The solvent may also include at least 3% by weight C7 hydrocarbon chains, at least 6% by weight C8 hydrocarbons, and at least 12% by weight C9 hydrocarbons.

According to the method of the invention, the solvent is formed by a process which utilizes rubber tires as the feed stock. More specifically, the method includes providing an enclosure having an interior chamber and plurality of internal baffles, and inputting the tire particles to the heated enclosure and moving these particles along a flow path positioned with respect to the plurality of baffles to provide a temperature gradient along the flow line of at least 150° F., thereby producing hydrocarbon vapors and residual solids. The method also includes rotating a drum in fluid communication with the flow line for receiving the tire particles and residual solids from the flow line, with the drum having an internal temperature of from 730° F. to 800° F. for generating hydrocarbon vapors and carbon black solids. Vapors are condensed from the flow line and the drum. Liquids including hydrocarbons are output from a condenser, while gas including hydrocarbons are also output from the condenser. A selected vacuum of at least 5 inches of water is maintained, such that hydrocarbon vapors are drawn from the flow line into the condenser. The desired solvent is extracted from the liquids output from the condenser.

These and further features and advantages of the present invention will become apparent from the following detailed description, wherein reference is made to the figures in the accompanying drawing.

### BRIEF DESCRIPTION OF THE DRAWINGS

FIG. 1 is a block diagram of a suitable system for producing the solvent.

### DESCRIPTION OF THE ILLUSTRATED EMBODIMENTS

A process as described below produces a multi-component solvent from tire scrap rubber. The liquid product or solvent is produced along with carbon black solids and gas. The gas may be used in the process to heat the reactor and/or may be sold. The solvent is a complex component mixture compared to competitive products produced from petroleum. The process thermatically and metallurgically reforms the constituents and binders of rubber and reforms them into the solvent. The high percentage of limonene and naphthalene in the solvent is the result of reformation of the rubber constituents.

The following detailed analysis of the solvent shows over 290 components with significant levels of limonene, napthalenes, toluene and xylenes. The solvent may be further refined to produce a wide range of valuable commodity products. The multi-component and heavy aromatic composition of the product is unique. The solvent has a vast potential for treating paraffin and asphaltene problems in oilfield production, pipeline and tank bottom stimulation applications.

| Compound | MW | CAS No. | % Range |
|---|---|---|---|
| Propylene | 42.1 | 115-07-1 | <1 |
| Propane | 44.1 | 74-98-6 | <1 |
| Isobutylene | 56.1 | 115-11-7 | <1 |
| Butane | 58.1 | 106-97-8 | <1 |
| Methyl Mercaptan | 48.2 | 74-93-1 | <1 |
| 3-Methyl-1-butene | 70.1 | 563-45-1 | <1 |
| Isopentane | 72.1 | 78-78-4 | <1 |
| 2-Methyl-1-butene | 70.1 | 563-46-2 | <1 |
| Isoprene | 68.1 | 78-79-5 | <1 |
| t-2-Pentene | 70.1 | 627-20-3 | <1 |
| Cyclopentadiene | 66.1 | 542-92-7 | <1 |
| C5H8 | 68.1 | 18631-83-9 | <1 |
| C6H12 | 84.1 | 558-37-2 | <1 |
| 3-Methylpentane | 86.1 | 96-14-0 | <1 |
| 1-Hexene | 84.1 | 592-41-6 | <1 |
| C6H12 | 84.1 | 760-21-4 | <1 |
| t-4-MethyI-2-pentene | 84.1 | 674-76-0 | <1 |
| t-3-Methyl-2-pentene | 84.1 | 616-12-6 | <1 |
| 3-Metylcyclopentene | 82.1 | 1120-62-3 | <1 |
| c-3-Methyl-2-pentene | 84.1 | 922-62-3 | <1 |
| Methylcyclopentane | 84.1 | 96-37-7 | <1 |
| t-2-Methyl-1,3-pentadiene | 82.1 | 926-54-5 | <1 |
| C6H8 | 80.1 | 592-57-4 | <1 |
| 1,3-Cyclohexadiene | 80.1 | 592-48-3 | <1 |
| C6H10 | 82.1 | 592-48-3 | <1 |
| Benzene | 78.1 | 71-43-2 | <1 |
| 1,4-Cyclohexadiene | 80.1 | 628-41-1 | <1 |
| 3-Methylhexane | 100.1 | 589-34-4 | <1 |
| Cyclohexene | 82.1 | 110-83-8 | <1 |
| t-1,2-Dimethylcyclopentane | 98.1 | 822-50-4 | <1 |
| 1-Heptene | 100.1 | 142-82-5 | <1 |
| C7H12 | 96.1 | 999-78-0 | <1 |
| c-3-Methyl-2-hexene | 98.1 | 10574-36-4 | <1 |
| 1,5-Dimethylcyclopentene | 96.1 | 16491-15-9 | <1 |
| C7H14 | 98.1 | 10574-37-5 | <1 |
| 5,5-Dimethyl-1,3-cyclopentadiene | 94.1 | 4125-18-2 | <1 |
| Methylcyclohexene | 96.1 | 591-49-1 | <1 |
| Ethylcyclopentane | 98.1 | 1640-89-7 | <1 |
| Methyl Isobutyl Ketone (MIBK) | 100.1 | 108-10-1 | <1 |
| Methyl-t-1,3,5-hexatriene | 94.1 | 24587-26-6 | <1 |
| C7H10 | 94.1 | 4313-57-9 | <1 |
| 1,3-Dimethylcyclopentadiene | 94.1 | 4784-86-5 | <1 |
| 1,5-Dimethylcyclopentene | 96.1 | 16491-15-9 | <1 |
| 3-Ethylcyclopentene | 96.1 | 694-35-9 | <1 |
| Methyl-t-1,3,5-hexatriene | 94.1 | 19264-50-7 | <1 |
| 2-Methylheptane | 114.1 | 592-27-8 | <1 |
| Toluene | 92.1 | 108-88-3 | 2–6 |
| Methylcyclohexene | 96.1 | 591-49-1 | <1 |
| 1,3-Cycloheptadiene | 94.1 | 4054-38-0 | <1 |
| 4-Methyl-1,4-Hexadiene | 96.1 | 1116-90-1 | <1 |
| C8H16 | 112.1 | 2207-04-7 | <1 |
| C7H12O | 112.1 | 4541-32-6 | <1 |
| 1-Octene | 112.1 | 111-66-0 | <1 |
| Octane | 114.1 | 111-65-9 | <1 |
| Vinylcyclohexane | 110.1 | 695-12-5 | <1 |
| C8H12 | 108.1 | 2809-84-9 | <1 |
| C8H16 | 112.1 | 2207-03-6 | <1 |
| 4-Ethylcyclohexene | 110.1 | 3742-42-5 | <1 |
| C8H12 | 108.1 | 4430-91-5 | <1 |
| c-2-Octene | 112.1 | 7642-04-8 | <1 |
| C8H14 | 110.1 | 29253-64-3 | <1 |
| Isopropylcyclopentene | 110.1 | 1462-07-3 | <1 |
| C8H14 | 110.1 | 1000142-17-5 | <1 |
| Dimethylcyclohexene | 110.1 | 56021-63-7 | <1 |
| Dimethylcyclohexene | 110.1 | 70688-47-0 | <1 |
| C9H14 | 122.1 | 37439-53-5 | <1 |
| Trimethylcyclohexane | 126.1 | 3073-66-3 | <1 |
| C8H12 | 108.1 | 4430-91-5 | <1 |
| C9H14 | 122.1 | 4249-12-1 | <1 |
| C8H12 | 108.1 | 83615-96-7 | <1 |
| Tetrahydromethylthiophene | 102.2 | 1795-09-1 | <1 |
| C9H16 | 124.1 | 37050-05-8 | <1 |
| C8H12 | 108.1 | 818-48-4 | <1 |
| C9H16 | 124.1 | 61142-34-5 | <1 |
| Ethylbenzene | 106.1 | 100-41-4 | 1–4 |
| C8H12 | 108.1 | 1000192-48-8 | <1 |
| C9H16 | 124.1 | 20184-89-8 | <1 |
| m-Xylene | 106.1 | 108-38-3 | 1–4 |
| p-Xylene | 106.1 | 106-42-3 | <1 |
| C8H12 | 108.1 | 1000150-54-4 | <1 |
| Dimethylthiophene | 112.2 | 638-00-6 | <1 |
| C8H12O | 124.1 | 1767-84-6 | <1 |
| Dimethylthiophene | 112.2 | 632-16-6 | <1 |
| Styrene | 104.1 | 100-42-5 | <1 |
| o-Xylene | 106.1 | 95-47-6 | 1–2 |
| C9H18 | 126.1 | 6434-78-2 | <1 |
| C8H10O | 122.1 | 2220-40-8 | <1 |
| C8H12 | 108.1 | 72347-62-7 | <1 |
| C9H14 | 122.1 | 1000196-61-0 | <1 |
| C9H14 | 122.1 | 1000162-25-6 | <1 |
| Pentamethylcyclopentadiene | 136.1 | 4045-44-7 | <1 |
| C9H16 | 124.1 | 4634-87-1 | <1 |
| Isopropylbenzene (Cumene) | 120.1 | 98-82-8 | <1 |
| C10H18 | 138.1 | 3983-03-7 | <1 |
| C10H16 | 136.1 | 1000163-57-0 | <1 |
| Propylcyclohexene | 124.1 | 2539-75-5 | <1 |
| C10H16 | 136.1 | 99-85-4 | <1 |
| C10H18 | 138.1 | 7712-74-5 | <1 |
| C8H12O | 124.1 | 1000196-10-0 | <1 |
| C10H18 | 138.1 | 5256-65-5 | <1 |
| C10H16 | 136.1 | 42123-66-0 | <1 |
| 2-Propenylbenzene | 118.1 | 300-57-2 | <1 |
| C9H14O | 138.1 | 100144-30-7 | <1 |
| C10H18 | 138.1 | 20536-41-8 | <1 |
| C10H16 | 136.1 | 61141-57-9 | <1 |
| Propylbenzene | 120.1 | 103-65-1 | <1 |
| 1-Decene | 140.1 | 872-05-9 | <1 |
| C10H16 | 136.1 | 5989-54-8 | <1 |
| Ethyltoluene isomer | 120.1 | 622-96-8 | 1–2 |
| Ethyltoluene isomer | 120.1 | 620-14-4 | 1–2 |
| 1,3,5-Trimethylbenzene | 120.1 | 108-67-8 | <1 |
| C10H16 | 136.1 | 74663-83-5 | <1 |
| Aniline | 93.1 | 62-53-3 | <1 |
| Ethyltoluene isomer | 120.1 | 611-14-3 | <1 |
| Alpha-Methylstyrene | 118.1 | 98-83-9 | <1 |
| C10H16 | 136.1 | 7216-56-0 | <1 |
| C10H18 | 138.1 | 33501-88-1 | <1 |
| C10H18 | 138.1 | 31222-43-2 | <1 |
| 1,2,4-Trimethylbenzene | 120.1 | 95-63-6 | 1–3 |
| C10H18 | 138.1 | 74630-29-8 | 1–2 |
| C10H16 | 136.1 | 18172-67-3 | <1 |
| C9H14 | 122.1 | 37439-53-5 | <1 |
| C10H18 | 138.1 | 61228-10-2 | <1 |
| C10H16 | 136.1 | 33622-26-3 | <1 |
| 2-Caren (C10H16) | 136.1 | 1000149-94-6 | <1 |
| 1,2,3-Trimethylbenzene | 120.1 | 526-73-8 | 1–2 |
| Isopropyltoluene isomer | 134.1 | 527-84-4 | 1–4 |
| Limonene | 136.1 | 5989-27-5 | 10–25 |
| Indane | 118.1 | 496-11-7 | <1 |
| Beta-Pinene | 136.1 | 127-91-3 | <1 |
| Indene | 116.1 | 95-13-6 | <1 |
| Diethylbenzene isomer | 134.1 | 141-93-5 | <1 |
| Propyltoluene isomer | 134.1 | 1074-43-7 | <1 |
| 2-Methylphenol | 108.1 | 95-48-7 | <1 |
| Diethylbenzene isomer | 134.1 | 135-01-3 | 1–2 |
| 1-Methylpropylbenzene | 134.1 | 135-98-8 | <1 |
| 4-Methylphenol | 108.1 | 106-44-5 | <1 |
| Dimethylethylbenzene | 134.1 | 934-80-5 | <1 |
| Isopropyltoluene isomer | 134.1 | 99-87-6 | <1 |
| 2-Propenyltoluene | 132.1 | 1587-04-8 | <1 |
| Dimethylethylbenzene | 134.1 | 933-98-2 | <1 |
| 4-Carene (C10H16) | 136.1 | 29050-33-7 | <1 |
| Isopropyltoluene isomer | 134.1 | 535-77-3 | <1 |
| Isopropenyltoluene isomer | 132.1 | 1195-32-0 | 1–2 |
| Dimethylstyrene isomer | 132.1 | 2039-89-6 | <1 |
| Isobutyltoluene isomer | 148.1 | 5161-04-6 | <1 |
| sec-butyltoluene isomer | 148.1 | 1595-16-0 | <1 |
| 1,2,4,5-Tetramethylbenzene | 134.1 | 95-93-2 | <1 |
| 1,2,3,4-Tetramethylbenzene | 134.1 | 488-23-3 | <1 |
| 2-Propenyltoluene | 132.1 | 3333-13-9 | <1 |
| C11H14 | 146.1 | 97664-18-1 | <1 |
| Dimethylstyrene isomer | 132.1 | 2234-20-0 | <1 |
| C11H16 | 148.1 | 4706-89-2 | <1 |
| Methylindane isomer | 132.1 | 824-22-6 | <1 |
| Methylindane isomer | 132.1 | 767-58-8 | <1 |
| Methylindene isomer | 130.1 | 2177-47-1 | <1 |
| Methylindene isomer | 130.1 | 767-59-9 | <1 |
| Methylindene isomer | 130.1 | 767-60-2 | <1 |
| C10H10 | 130.1 | 2288-18-8 | <1 |
| Methylbenzyl Alcohol isomer | 122.1 | 89-95-2 | <1 |
| C10H10 | 130.1 | 15677-15-3 | <1 |
| C11H16 | 148.1 | 2049-95-8 | <1 |
| C11H14 | 146.1 | 56253-64-6 | <1 |
| C11H14 | 146.1 | 6682-71-9 | <1 |
| Naphthalene | 128.1 | 91-20-3 | <1 |
| C11H14 | 146.1 | 17059-48-2 | <1 |
| 1-Dodecene | 168.2 | 112-41-4 | <1 |
| Dimethylindane isomer | 146.1 | 17057-82-8 | <1 |
| C6-Alkylbenzene | 162.1 | 55669-88-0 | <1 |
| C6-Alkylthiophene | 168.3 | 54411-06-2 | <1 |
| C6-Alkylbenzene | 162.1 | 102-25-0 | <1 |
| C11H14 | 146.1 | 53172-84-2 | <1 |
| Benzothiazole | 135.1 | 95-16-9 | 1–2 |
| Methyltetralin | 146.1 | 2809-64-5 | <1 |
| Trimethylindane isomer | 160.1 | 40650-41-7 | <1% |
| Trimethylindane isomer | 160.1 | 2613-76-5 | <1 |
| Ethylindene | 144.1 | 17059-50-6 | <1 |
| Dimethylindane isomer | 146.1 | 6682-71-9 | <1 |
| Dimethylindene isomer | 144.1 | 2177-48-2 | <1 |
| Dimethylindene isomer | 144.1 | 4773-82-4 | <1 |
| Dimethylindene isomer | 144.1 | 18636-55-0 | <1 |
| Methyldihydronaphthalene | 144.1 | 2717-44-4 | <1 |
| C12H14 | 158.1 | 1605-18-1 | <1 |
| 1-Tridecene | 182.2 | 2437-56-1 | <1 |
| Dimethyltetralin isomer | 160.1 | 25419-33-4 | <1 |
| Tridecane | 184.2 | 629-50-5 | <1 |
| Methylbenzothiazole | 149.1 | 120-75-2 | <1 |
| 2-Methylnaphthalene | 142.1 | 91-57-6 | <1 |
| Trimethylindene isomer | 158.1 | 4773-83-5 | <1 |
| Trimethylindene isomer | 158.1 | 2177-45-9 | <1 |
| C13H20 | 176.2 | 1595-03-5 | <1 |
| 1-Methylnaphthalene | 142.1 | 90-12-0 | <1 |
| C12H16 | 160.1 | 14679-13-1 | <1 |
| Dimethyltetralin isomer | 160.1 | 4175-54-6 | <1 |
| Trimethylindane isomer | 160.1 | 54340-88-4 | <1 |
| Dimethyltetralin isomer | 160.1 | | <1 |
| Trimethylindene isomer | 158.1 | | <1 |
| Trimethylindene isomer | 158.1 | | <1 |
| Trimethylindene isomer | 158.1 | | <1 |
| Trimethylindene isomer | 158.1 | | <1 |
| Biphenyl | 154.1 | 92-52-4 | <1 |
| 1-Tetradecene | 196.2 | 1120-36-1 | <1 |
| Dimethylbenzothiophene | 162.3 | 16587-48-7 | <1 |
| Tetradecane | 198.2 | 629-59-4 | <1 |
| Ethylnaphthalene | 156.1 | 1127-76-0 | <1 |
| Dimethylnaphthalene | 156.1 | 571-61-9 | <1 |
| Dimethylnaphthalene | 156.1 | 582-16-1 | <1 |
| Dimethylnaphthalene | 156.1 | 575-41-7 | <1 |
| Dimethylnaphthalene | 156.1 | 573-98-8 | 1–2 |
| C9-Alkylthiophene | 210.3 | 5206-09-7 | <1 |
| Dimethylquinoline | 157.1 | 877-43-0 | <1 |
| C15H24 | 204.2 | 470-40-6 | <1 |
| C10H18 | 138.1 | 74630-29-8 | <1 |
| Dimethylnaphthalene | 156.1 | 581-42-0 | <1 |
| C15H26 | 206.2 | 1000156-14-5 | <1 |
| C15H22 | 202.2 | 644-30-4 | <1 |
| C15H22 | 202.2 | 16982-00-6 | <1 |
| Methylbiphenyl | 168.1 | 644-08-6 | <1 |
| Pentadecane | 212.3 | 629-62-9 | <1 |
| Methylbiphenyl | 168.1 | 643-58-3 | <1 |
| Trimethylnaphthalene | 170.1 | 2245-38-7 | <1 |
| C15H26 | 206.2 | 13567-54-9 | <1 |
| Trimethylnaphthalene | 170.1 | 829-26-5 | <1 |
| Trimethylnaphthalene | 170.1 | 2131-42-2 | <1 |
| Trimethylnaphthalene | 170.1 | 2131-41-1 | 1–2 |
| Trimethylazulene | 170.1 | 941-81-1 | <1 |
| Dimethylbiphenyl | 182.1 | 605-39-0 | <1 |
| C14H16 | 184.1 | 490-65-3 | <1 |
| 1-Hexadecene | 224.3 | 629-73-2 | <1 |
| C3-Alkylbenzothiophene | 190.3 | 18428-05-2 | <1 |
| Hexadecane | 226.3 | 544-76-3 | <1 |
| Dimethylbiphenyl | 182.1 | 612-75-9 | <1 |
| Isopropenylnaphthalene | 168.1 | 1855-47-6 | <1 |
| 2-Methylthibenzothiazole | 181.4 | 615-22-5 | <1 |
| 1,1-Diphenylhydrazine | 184.1 | 530-50-7 | <1 |
| Tetramethylnaphthalene | 184.1 | 3031-15-0 | <1 |
| Triethylacetophenone | 204.2 | 2715-54-0 | <1 |
| 1,3-Diphenylpropane | 196.1 | 1081-75-0 | <1 |
| Benzothiazolone | 151.2 | 934-34-9 | <1 |
| Tetramethylnaphthalene | 184.1 | | <1 |
| C5-Alkylnaphthalene | 198.1 | 483-78-3 | <1 |
| C4-Alkylbenzothiophene | 190.1 | 18428-05-2 | <1 |
| 1-Heptadecene | 238.3 | 6765-39-5 | <1 |
| Tetramethylnaphthalene | 184.1 | | <1 |
| Heptadecane | 240.3 | 629-78-7 | <1 |
| C13H20O | 184.1 | 613-37-6 | <1 |
| Methylfluorene | 180.1 | 1430-97-3 | <1 |
| Methylfluorene | 180.1 | 1556-99-6 | <1 |
| Methylfluorene | 180.1 | 1730-37-6 | <1 |
| Tetramethylnaphthalene | 184.1 | | <1 |
| Diphenylamine | 183.1 | 552-82-9 | <1 |
| Dimethylbiphenyl | 182.1 | 611-43-8 | <1 |
| Dimethylbiphenyl | 182.1 | 611-61-0 | <1 |
| C3-Alkylbiphenyl | 196.1 | 7116-95-2 | <1 |
| Dimethylbiphenyl | 182.1 | 613-33-2 | <1 |
| 1-Octadecene | 252.3 | 112-88-9 | <1 |
| Octadecane | 254.3 | 593-45-3 | <1 |
| Phenanthrene | 178.1 | 85-01-8 | <1 |
| Anthracene | 178.1 | 120-12-7 | <1 |
| Methyldihydroanthracene | 194.1 | 948-67-4 | <1 |
| Dimethylfluorene | 194.1 | 4612-63-9 | <1 |
| Alpha-Methylstilbene | 194.1 | 833-81-8 | <1 |
| C14H24 | 192.2 | 1000149-59-0 | <1 |
| C15H16 | 196.1 | 28122-28-3 | <1 |
| C15H16 | 196.1 | 620-85-9 | <1 |
| C15H16 | 196.1 | 28122-27-2 | <1 |
| Phenylnaphthalene | 204.1 | 605-02-7 | <1 |
| C3-Alkylbiphenyl | 196.1 | 20282-30-8 | <1 |
| 1-Nonadecene | 266.3 | 18435-45-5 | <1 |
| Nonadecane | 268.3 | 629-92-5 | <1 |
| Methylanthracene | 192.1 | 610-48-0 | <1 |
| Methylanthracene | 192.1 | 779-02-2 | <1 |
| C16H16 | 208.1 | 2919-20-2 | <1 |
| Methylanthracene | 192.1 | 613-12-7 | <1 |
| Hexadecanoic Acid | 256.2 | 57-10-3 | <1 |
| Phenylnaphthalene | 204.1 | 35465-71-5 | <1 |
| Dimethylphenanthrene | 206.1 | 3674-69-9 | <1 |
| C19H28 | 256.2 | 1000197-14-1 | <1 |
| Dimethylanthracene | 206.1 | 781-43-1 | <1 |
| Dimethylphenanthrene | 206.1 | 1576-67-6 | <1 |
| Dimethylphenanthrene | 206.1 | 1576-69-8 | <1 |
| Butylated Hydroxytoluene | 220.2 | 128-37-0 | <1 |
| Fluoranthene | 202.1 | 206-44-0 | <1 |
| Heneicosane | 296.3 | 629-94-7 | <1 |
| Hexadecanenitrile | 251.3 | 5399-02-0 | <1 |
| 2-Propenylanthracene | 218.1 | 23707-65-5 | <1 |
| Diisopropylbiphenyl | 238.2 | 69009-90-1 | <1 |
| Pyrene | 202.1 | 129-00-0 | <1 |
| Trimethylphenanthrene | 220.1 | 3674-73-5 | <1 |
| Docosane | 310.4 | 629-97-0 | <1 |
| C4-Alkylphenanthrene | 234.1 | 483-65-8 | <1 |
| Tricosane | 324.4 | 638-67-5 | <1 |
| Tetracosane | 338.4 | 646-31-1 | <1 |
| Chrysene | 228.1 | 218-01-9 | <1 |
| Pentacosane | 352.4 | 629-99-2 | <1 |
| Benz[a]anthracene | 228.1 | 56-55-3 | <1 |

As discussed above, the multi-component mixture of the solvent enables it to dissolve the entire spectrum of waxes and asphaltene deposits. The solvent includes a large percentage of unsaturates and aromatics, which give the solvent the ability to maintain solids in suspension for extended periods of time compared to other solvents. Once a paraffin substance is treated, the paraffins are not likely to recombine due to unsaturates molecular structure that creates an ionic repulsion effect.

The solvent also has the ability to stay bonded to metallic surfaces for extended periods of time. This characteristic further enhances the solvent's ability to be a lubricant as well which further separates the solvent from other produced solvents.

A summary of the lab analysis on a solvents manufactured by this technique follows, with percentages expressed as a weight percent.

1. Content of light (gas) non-alkane hydrocarbons (C1 to C5)=2.5%

The content of these light hydrocarbons may vary from less than 1% to about 4%, depending on operating parameters for the process. Although a low percentage of light hydrocarbons thus will typically be present in a solvent manufactured in this manner, the light hydrocarbons are not considered particularly important in satisfying the solvent's ability to dissolve waxes and paraffins. The C1-C5 hydrocarbon materials are not considered significant to the desired solvent characteristics. These light hydrocarbons could be removed from the solvent by conventional techniques.

2. Total content of C6 to C25=about 96% to 99.5%
Of which about 12.8% by weight of the solvent was LIMONENE
Of which 9.5% by weight of the solvent was NAPHTHALENES

The weight percentage of limonene and the percentage of naphthalenes are particularly significant, and it is believed that their combination increases the effectiveness of the solvent when both the limonene and the naphthalenes have a significant weight percentage. The percentage of limonene may be 6% or more, and preferably in the range of from 8% to 25%. The percentage of naphthalenes may be 6% or more, and in the range of from 8% to 14%. In more preferred embodiments, the weight percentage of limonene in the solvent may be about 10%, and the weight percentage of naphthalenes in the solvent may also be about 10%.

The term “limonene” as used herein refers to dl-limonene, which is also referred to as dipentene. The term “naphthalenes” as used herein broadly refers to any of the chemical components having a hydrocarbon chain based upon C10H8 molecules, and includes methyldihydronaphthalene (C11), 2-methylnaphthalene (C11), 1-methylnaphthalene (C11), dimethylnaphthalene (C12), trimethylnaphthalene (C13), isopropenylnaphthalene (C13), tetramethylnaphthalene (C14), C5-alkylnaphthalene (C15), and phenylnaphthalene (C16). The term “C10” as used herein means chemical components with a carbon number of 10, and includes limonene and some of the naphthalenes. Similarly, the terms “C6”, “C7”, “C8”, “C9”, “C11” and “C12” mean chemical components with a carbon number of 6, 7, 8, 9, 11 and 12, respectively.

3. The breakdown of the C6's through C12's are as follows:

| | | |
|---|---|---|
| C6 | at least 1% | (Carbon Number = 6) |
| C7 | at least 3% | (Carbon Number = 7) |
| C8 | at least 6% | (Carbon Number = 8) |
| C9 | at least 12% | (Carbon Number = 9) |
| C10 | at least 5% | (Carbon Number = 10) |
| C11 | at least 6% | (Carbon Number = 11) |
| C12 | at least 6% | (Carbon Number = 12) |
| C13 | at least 3% | (Carbon Number = 13) |
| C14 | at least 1% | (Carbon Number = 14) |
| C15 | at least 2% | (Carbon Number = 15) |

From the above, it should be understood that each of the C6 hydrocarbon materials, the C7 hydrocarbon materials, the C8 hydrocarbon materials and the C9 hydrocarbon materials comprise at least 25% by weight of the solvent. Also, the C10 hydrocarbon materials also comprise at least 25% by weight of the solvent. The majority of the C10 constituents are from the limonene. C10 hydrocarbons weight percentage is preferably in excess of 20% of the solvent by weight. C6 and C7 hydrocarbons also comprise a significant percent by weight of the solvent, and both the C6 and C7 materials may be by weight at least 2% and 3%, respectively, for most applications.

A relatively low amount of C6 hydrocarbon materials, e.g., from 1-3% by weight of the solvent, may be present, although there may be applications where it is preferred to significantly reduce or eliminate these materials from the solvent, along with the removal of the light C1-C5 hydrocarbon materials, as discussed above.

Percentage by weight of hydrocarbon materials drops significantly after the C10 materials. In a preferred embodiment, the solvent may include from 6-8% by weight C-11 hydrocarbon materials, and may also include from 6-9% by weight C12 hydrocarbon materials. For numbers higher than C12, the percentage by weight again is reduced, and from 3-6% by weight of the solvent may be C13 hydrocarbon materials and from 1-4% by weight may be C14 hydrocarbon materials. The solvent may include from 2-6% by weight C15 hydrocarbon materials, and from 2-6% by weight C16-C25 hydrocarbon materials. In one embodiment, the solvent preferably comprises by weight at least 5% C-10 through C-25 hydrocarbon materials.

The breakout of the C13 and larger carbon chains is more difficult to determine, since many constituents of these larger chains are not easily identifiable with their C—H makeup. From the above, these C13 and larger chains comprise about 15% or less of the solvent.

Physical Properties

| | |
|---|---|
| Appearance: | Brown Liquid |
| Viscosity @ 100 Degrees F.: | 2.1, cSt |
| Boiling Point Range: | 40 Degrees C. (IBP)–200 Degrees C. |
| Specific Gravity @ 60 Degrees F.: | 0.9195 |
| API Gravity @ 69 Degrees F.: | 22.3 Degrees F. |
| Flash Point, PM: | 69 Degrees F. |
| Freezing Point: | <−5 Degrees F. |

According to the method of manufacturing a solvent from waste tires, an enclosure may be provided having an interior chamber and a plurality of baffles. Tire particles may be input to the heated enclosure and move along a flow line positioned with respect to the plurality of baffles to provide a temperature gradient along the flow line of at least 150° F., thereby producing hydrocarbon vapors and residual solids. The drum in fluid communication with the flow line is rotated for receiving the tire particles and residual solids from the flow line, with the drum having an interior temperature of from 730° F. to 800° F. for generating hydrocarbon vapors and carbon black solids. The vapors from the flow line of the drum are condensed, and the output includes liquid hydrocarbons from the condenser and gas including hydrocarbons from the condenser. A selected vacuum of at least 5 inches of water is maintained, such that hydrocarbon vapors are drawn from the flow line into the condenser. Solvent may be extracted from the liquids output from the condenser. In many cases, a useful solvent may be generated simply by separating the hydrocarbon materials from water, so that the water is discharged or returned back to the system, with the remaining solvent serving the highly useful purposes as disclosed herein.

At least a portion of the gas produced may be input into a burner within the enclosure to reduce the fuel cost to the system. Fuel to the burner may specifically be controlled as a function of the measured drum temperature. In a preferred embodiment, the flow line extends in one axial direction, and in a substantially opposing axial direction within the chamber. Carbon black solids may be discharged from the drum.

In a preferred embodiment, steam is input to the drum at a temperature of greater than 800° F. The rotary drum is heated to an interior temperature of from 730° F. to 800° F. for generating hydrocarbon vapors and carbon black solids. Preferably a drum magnet may be used to remove metal particles from the rubber particles prior to the material entering the heated chamber.

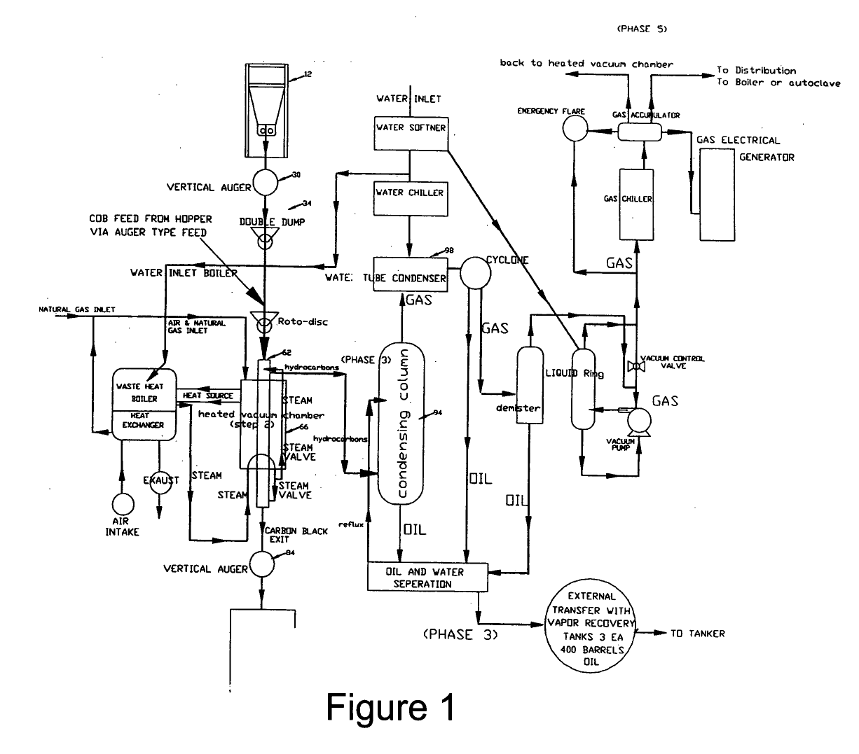

FIG. 1 illustrates the primary components of the system in schematic form. Material from the conveyor 12 thus passes upward through the vertical auger 30, through the double-dump valve 34, and through the conveyor 62 into the heated enclosure 66. Carbon black discharged from the enclosure is passed through the vertical auger 84 and may then be packaged for sale.

Hydrocarbons discharged from the heated enclosure 66 pass to the condensing column 94, with gas continuing to the water tube condenser 98, and are then input by a cyclone pump to a demister, and finally to a gas chiller. A liquid ring with a vacuum pump may be spaced fluidly between the fragmentator and the gas chiller. Other than the gas released through an emergency flare, gas from the chiller may be input to a gas accumulator, and to a gas electrical generator. Some of the gas may be returned to the heated enclosure, and other gas may pass to the boiler. Produced hydrocarbons may thus be recovered in holding tank 102, and may be passed to a burner 104 within the heated enclosure 66 to generate heat. The system may thus primarily run on its own produced gas once the reaction starts to occur.

A water condenser is provided with internal coils preferably fabricated from stainless steel. Water may be treated with a water softening system and will be continuously circulated through a water chiller while flowing through the condenser to maintain a constant temperature and reduce the rate of corrosion. The water softener may be used to input water to the liquid isolation chamber, and also the waste heat boiler. Steam from the boiler may be input to the heated enclosure 66, as discussed above. The oil and water separator 102 may receive oil and water from various locations in the system, but primarily from the condensing column 94. Separated water may be discharged to waste treatment or input back to the system. The oil, which is termed a solvent in this application, may be separated from the water and selectively output from separator 102 to drums or other containers for sale.

Other oilfield applications may use this solvent for corrosion inhibitors, paraffin inhibitors, asphaltene inhibitors, paraffin dispersing, surfactants, emulsion breakers, anti-sludge agents, inverted drilling mud, friction reducers, frac fluid loss agent, liquid gel concentrates, oil soluble acids, acid corrosion inhibitors, hydrocarbon foaming agents, and emulsified acid systems.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations, and modifications, including but not limited to those design alternatives specifically discussed herein, may be made in the practice of the invention without departing from its scope.

What is claimed is:

1. A solvent, comprising:
at least 3% by weight C7 hydrocarbon materials;
at least 6% by weight C8 hydrocarbon materials;
at least 12% by weight C9 hydrocarbon materials;
at least 6% by weight limonene; and
at least 6% by weight naphthalenes.

2. A solvent as defined in claim 1, wherein the limonene is from 8-25% by weight.

3. A solvent as defined in claim 1, wherein the naphthalenes are from 8-14% by weight.

4. A solvent as defined in claim 1, wherein the C7 hydrocarbon materials are at least 5% by weight of the solvent.

5. A solvent as defined in claim 1, wherein C-1 to C-5 hydrocarbon materials comprise from 2-5% by weight of the solvent.

6. A solvent as defined in claim 1, wherein the solvent comprises at least 2% by weight C6 hydrocarbon materials.

7. A solvent as defined in claim 6, wherein the C6 hydrocarbon materials comprise at least 4% by weight of the solvent.

8. A solvent as defined in claim 1, wherein C10 hydrocarbons comprise at least 25% by weight of the solvent.

9. A solvent as defined in claim 1, wherein C-13 and higher hydrocarbon materials comprise less than 9% by weight of the solvent.

10. A solvent comprising:
from 4%-8% by weight C7 hydrocarbon materials;
from 8%-12% by weight C8 hydrocarbon materials;
from 14%-20% by weight C9 hydrocarbon materials; and
from 25%-40% by weight C10 hydrocarbon materials.

11. A solvent as defined in claim 10, wherein the solvent further comprises:
from 6%-8% by weight C11 hydrocarbon materials.

12. A solvent as defined in claim 10, wherein the solvent further comprises:
from 6%-9% by weight C12 hydrocarbon materials.

13. A solvent as defined in claim 10, wherein the solvent further comprises:
from 3%-6% by weight C13 hydrocarbon materials.

14. A solvent as defined in claim 10, wherein the solvent further comprises:
from 1%-4% by weight C14 hydrocarbon materials.

15. A solvent as defined in claim 10, wherein the solvent further comprises:
from 2%-6% by weight C15 hydrocarbon materials.

16. A solvent as defined in claim 10, wherein the solvent further comprises:
from 2%-6% by weight C16-C25 hydrocarbon materials.

17. A solvent as defined in claim 10, wherein the C10 hydrocarbon materials comprise at least 6% limonene by weight of the solvent, and at least 6% naphthalenes by weight of the solvent.

18. A solvent as defined in claim 17, wherein the limonene is from 8-25% by weight of the solvent.

19. A solvent as defined in claim 10, wherein the naphthalenes are from 8-14% by weight of the solvent.

20. A solvent as defined in claim 10, wherein the solvent comprises from 1%-3% C6 hydrocarbon materials by weight of the solvent.

21. A method of manufacturing a solvent from waste tires, the method comprising:
providing an enclosure having an interior chamber and a plurality of internal baffles;
inputting the tire particles to the heated enclosure and moveable along a flow line positioned with respect to the plurality of baffles to provide a temperature gradient along the flow line of at least 150 F.°, thereby producing hydrocarbon vapors and residual solids;
rotating a drum in fluid communication with the flow line for receiving the tire particles and residual solids from the flow line, the drum having an interior temperature of from 730° F. to 800° F. for generating hydrocarbon vapors and carbon black solids;
condensing vapors from the flow line and the drum and outputting liquids including hydrocarbons from condenser and gas including hydrocarbons from the condenser;
maintaining a selected vacuum of less than 5 inches of water, such that hydrocarbon vapors are drawn from the flow line into the condenser;
extracting the solvent from the liquids output from the condenser.

22. A method as defined in claim 21, wherein at least a portion of the one or more gas including hydrocarbons are input into a burner within the enclosure.

23. The system as defined in claim 21, wherein fuel to the burner is controlled as a function of measured drum temperature.

24. A method as defined in claim 21, wherein the flow line extends in one axial direction and in a substantially opposing axial direction within the chamber.

25. A method as defined in claim 21, further comprising:
discharging the carbon black solids from the drum.

26. A method as defined in claim 21, wherein a drum magnet removes metal particles from rubber particles.

27. A method as defined in claim 21, further comprising:
inputting steam at a temperature of greater than 800° F. into the drum.

28. A method as defined in claim 21, wherein the rotary drum is heated to an interior temperature of from 730° F. to 800° F. for generating hydrocarbon vapors and carbon black solids.
